(19) United States
(12) Patent Application Publication
(10) Pub. No.: US 2025/0161986 A1
(43) Pub. Date: May 22, 2025

(54) ULTRASONIC-WAVE IRRADIATION UNIT

(71) Applicant: HONDA ELECTRONICS CO., LTD., Aichi (JP)

(72) Inventors: Nobunaga SHIBUYA, Aichi (JP); Yoshihiro AOKI, Aichi (JP)

(73) Assignee: HONDA ELECTRONICS CO., LTD., Aichi (JP)

(21) Appl. No.: 18/949,292

(22) Filed: Nov. 15, 2024

(30) Foreign Application Priority Data
Nov. 17, 2023 (JP) 2023-195639

(51) Int. Cl. B06B 1/06; B08B 3/12

(52) U.S. Cl. CPC B06B 1/064; B08B 3/12; B06B 2201/71

(57) ABSTRACT

The ultrasonic-wave irradiation unit provides excellent erosion resistance, ensuring a long service life, and achieves uniform oscillation displacement distribution, thereby minimizing uneven cleaning. The ultrasonic-wave irradiation unit comprises a diaphragm and a plurality of transducer units U1. Each transducer unit U1 includes a plurality of ultrasonic transducers, a resonator, and a connecting plate that transmits the oscillations of the ultrasonic transducers to the resonator. The connecting plate 61 has peaks and valleys along both side edges, forming alternating wide portions and narrow portions, with bolt insertion holes formed in the center of each wide portion. Adjacent connecting plates are arranged in a staggered manner in close proximity, such that the peaks of one plate fit into the valleys of the adjacent plate. The ultrasonic transducers and resonators are fastened and fixed to a plurality of bolts protruding through the bolt insertion holes of the connecting plate.

### TECHNICAL FIELD

The present invention relates to an ultrasonic-wave irradiation unit that irradiates ultrasonic waves from an ultrasonic transducer.

### TECHNICAL BACKGROUND

Conventionally, ultrasonic cleaning devices equipped with an ultrasonic-wave irradiation unit, which performs cleaning of an object to be cleaned (ultrasonic cleaning) by irradiating the cleaning liquid with ultrasonic waves, have been put into practical use. Ultrasonic cleaning combines the physical action of ultrasonic waves with the chemical action of the cleaning liquid, allowing it to act on even the fine details of objects having complex shapes, thereby enabling efficient cleaning. Consequently, ultrasonic cleaning has become indispensable in the manufacturing of precision mechanical parts, optical components, liquid crystal displays, semiconductors, and the like.

The conventional ultrasonic cleaning device 200 shown in FIG. 15 is equipped with a vibrating plate 201, which is also called a radiating plate. The vibrating plate 201 often serves as the bottom of the cleaning tank 202 and is formed of a stainless steel plate with a thickness of several millimeters. A plurality of bolt-clamped Langevin-type ultrasonic transducers 204 are joined to the non-irradiating surface 203 of the vibrating plate 201, which constitutes the ultrasonic-wave irradiation unit. The surface of the vibrating plate 201, located on the opposite side of the non-irradiating surface 203, serves as the ultrasonic irradiation surface 205. When an ultrasonic-wave irradiation unit, for example, generating ultrasonic waves of several tens of kHz, is used, an ultrasonic cleaning device 200 can be constructed in which cavitation in the cleaning liquid 206 caused by the ultrasonic waves produces strong shock waves to clean the object 207 to be cleaned.

### PRIOR ART DOCUMENTS

### Patent Documents

Patent Document 1: Japanese Patent Application Publication No. 2019-058883 (e.g., FIG. 1)

### SUMMARY OF THE INVENTION

### Problem to Be Solved by the Invention

When the cleaning area of the ultrasonic cleaning device 200 becomes larger, the irradiation surface of the diaphragm 201 also becomes larger accordingly. Therefore, when constructing the ultrasonic-wave irradiation unit, it is inherently desirable to install multiple ultrasonic transducers 204 on the diaphragm 201 with a large irradiation surface. However, if multiple ultrasonic transducers 204 are used to configure the ultrasonic-wave irradiation unit, the manufacturing cost of the device increases significantly. On the other hand, if the number of ultrasonic transducers 204 installed is not proportional to the size of the diaphragm 201, gaps (areas without transducers) will form between adjacent transducers. As a result, there is a problem where erosion 208 is generated on the diaphragm 201 due to cavitation. Furthermore, there is also a problem where uneven cleaning occurs due to the non-uniform oscillation displacement distribution of the diaphragm 201 (i.e., variations in sound pressure distribution).

To address these issues, the inventors of the present invention have previously proposed an ultrasonic-wave irradiation unit structure in which rod-shaped resonators are arranged between multiple ultrasonic transducers (for example, see Patent Document 1). This configuration reduces the areas without transducers or resonators on the non-irradiation surface. However, even with such a configuration, gaps still exist between the transducers and resonators, and it cannot be said that erosion reduction and uniformity of oscillation displacement distribution have been sufficiently achieved.

Furthermore, the inventors of the present invention have considered using a connecting plate in the aforementioned ultrasonic-wave irradiation unit structure, in which rod-shaped resonators are arranged between multiple ultrasonic transducers. Specifically, by using a connecting plate that mechanically connects the ultrasonic transducers and resonators and installing the ultrasonic transducers and resonators on the non-irradiation surface of the diaphragm via this connecting plate, it is considered possible to transmit the oscillations of the ultrasonic transducers to the resonators. However, even with such a configuration, it is expected that it would not be easy to arrange the ultrasonic transducers and resonators with sufficient density.

The present invention has been made in view of the above problems, and its objective is to provide an ultrasonic-wave irradiation unit that has excellent erosion resistance, resulting in a long service life, and achieves uniform oscillation displacement distribution, thereby reducing cleaning unevenness, all while being realized at a low cost.

### Means for Solving the Problem

To solve the above problems, the first aspect of the present invention refers to an ultrasonic-wave irradiation unit comprising: a diaphragm having an irradiation surface that emits ultrasonic waves and a non-irradiation surface located on the opposite side of the irradiation surface, with a plurality of bolts protruding from the non-irradiation surface; and a plurality of transducer units, each comprising a plurality of ultrasonic transducers, resonators, and a connecting plate; wherein the resonators are arranged between the plurality of ultrasonic transducers; wherein the connecting plate mechanically couples the plurality of ultrasonic transducers and the resonators and transmits the vibrations of the plurality of ultrasonic transducers to the resonators; wherein the connecting plate has alternating wide portions and narrow portions formed by having peaks and valleys along both side edges, and a plurality of bolt insertion holes are formed through the center of each of the wide portions to allow the bolts to pass through; wherein adjacent connecting plates are arranged in a staggered manner such that the peaks of one plate fit into the valleys of the other plate in close proximity; wherein the plurality of ultrasonic transducers and resonators are fastened and secured to the bolts protruding through the bolt insertion holes of the connecting plates, and a plurality of transducer units are installed on the non-irradiation surface side.

Therefore, according to the first aspect of the present invention, since a plurality of transducer units are used, each of which is mechanically coupled via a connecting plate to the plurality of ultrasonic transducers and resonators, the resonators are excited by the resonance phenomenon accompanying the oscillation of the ultrasonic transducers. In this case, the connecting plate functions as an irradiation plate for the transducer units composed of the plurality of ultrasonic transducers and resonators, making it possible to achieve uniform longitudinal oscillation over a relatively wide irradiation surface. Moreover, since adjacent connecting plates are arranged in close proximity such that the peaks of one plate are fitted into the valleys of the other, it is possible to arrange the ultrasonic transducers and resonators with sufficient density. As a result, bending oscillations occurring in the gaps between the transducer units are suppressed, thereby reducing the occurrence of erosion on the diaphragm and making it easier to obtain a uniform oscillation displacement distribution.

In addition, since the resonators have a simpler structure compared to the ultrasonic transducers, which are composed of multiple components, they can be manufactured at a relatively low cost. Similarly, the connecting plates, having a relatively simple structure, can also be manufactured at a relatively low cost through sheet metal processing such as stamping or laser cutting. Therefore, even in an ultrasonic-wave irradiation unit equipped with a diaphragm that requires a large cleaning area, it is possible to realize a device with excellent erosion resistance and uniform oscillation displacement distribution at a low cost by using inexpensive resonators and connecting plates instead of arranging a large number of ultrasonic transducers.

The second aspect of the present invention refers to the ultrasonic-wave irradiation unit of the first aspect, wherein the plurality of ultrasonic transducers and the resonators are both arranged in a staggered manner along the width direction of the transducer units.

The third aspect of the present invention refers to the ultrasonic-wave irradiation unit of the second aspect, wherein, when a specific transducer unit is designated as the reference unit and a transducer unit adjacent to the specific transducer unit is designated as the adjacent unit, and a line segment circumscribing the plurality of ultrasonic transducers belonging to the reference unit is assumed, the outer periphery of the ultrasonic transducers and the resonators belonging to the adjacent unit intersects the line segment.

The fourth aspect of the present invention refers to the ultrasonic-wave irradiation unit of the third aspect, wherein the peaks and valleys are formed regularly with an equal pitch.

The fifth aspect of the present invention refers to the ultrasonic-wave irradiation unit of any one of the first to fourth aspects, wherein the connecting plate has a structure in which a plurality of regular hexagonal plates are arranged and connected integrally in the planar direction.

The sixth aspect of the present invention refers to the ultrasonic-wave irradiation unit of any one of the first to fourth aspects, wherein adjacent connecting plates are arranged in close proximity with a gap of 0.1 mm or more and ⅛ or less of the longitudinal oscillation wavelength.

The seventh aspect of the present invention refers to the ultrasonic-wave irradiation unit of any one of the first to fourth aspects, wherein the thickness of the connecting plate is 1/200 or more and 1/10 or less of the longitudinal oscillation wavelength.

### Effect of the Invention

As described in detail above, according to the first to seventh aspects of the present invention, it is possible to realize an ultrasonic-wave irradiation unit with excellent erosion resistance and long service life, as well as uniform oscillation displacement distribution, which reduces cleaning unevenness, all while achieving low-cost manufacturing.

### BRIEF DESCRIPTION OF THE DRAWINGS

FIG. 1 is a schematic configuration diagram illustrating an ultrasonic cleaning device of the first embodiment.

FIG. 2 is a partially exploded perspective view illustrating the diaphragm-type ultrasonic-wave irradiation unit of the first embodiment.

FIG. 3 is a plan view illustrating the diaphragm-type ultrasonic-wave irradiation unit according to the first embodiment.

FIG. 4 is a perspective view illustrating a connecting plate used in the ultrasonic-wave irradiation unit of the first embodiment.

FIG. 5 is a side view illustrating the state prior to assembling the ultrasonic-wave irradiation unit of the first embodiment.

FIG. 6 is a side view illustrating the state after assembly of the ultrasonic-wave irradiation unit of the first embodiment.

FIG. 7 is a table illustrating the oscillation displacement analysis results of Comparative Embodiments 1, 2, and the present embodiment.

FIGS. 8A and 8B are plan views illustrating the state where adjacent connecting plates are arranged in close proximity in the transducer units of the present embodiment.

FIGS. 9A and 9B are plan views illustrating the state where adjacent connecting plates are arranged in close proximity in the transducer units of Comparative Embodiment 3.

FIG. 10 is a perspective view illustrating the diaphragm-type ultrasonic-wave irradiation unit of the second embodiment.

FIG. 11 is a plan view illustrating the diaphragm-type ultrasonic-wave irradiation unit of another embodiment.

FIG. 12 is a side view illustrating the state after assembly of the ultrasonic-wave irradiation unit of another embodiment.

FIGS. 13A and 13B are plan views illustrating the state where adjacent connecting plates are arranged in close proximity in the transducer units of another embodiment.

FIGS. 14A and 14B are plan views illustrating the state where adjacent connecting plates are arranged in close proximity in the transducer units of another embodiment.

FIG. 15 is a schematic configuration diagram illustrating an ultrasonic cleaning device of the prior art.

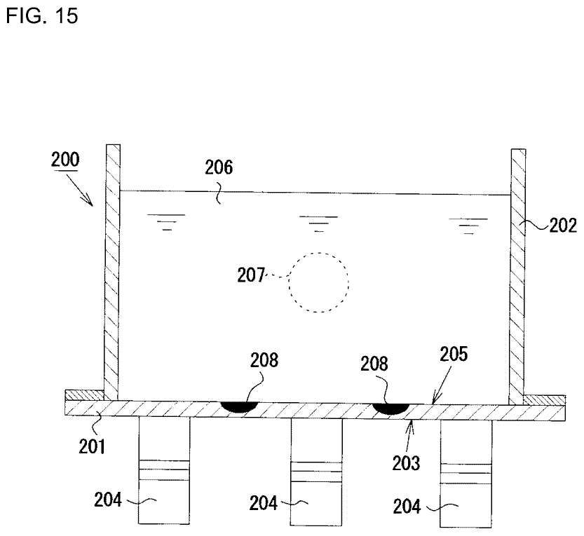

### MODES FOR CARRYING OUT THE INVENTION

### First Embodiment

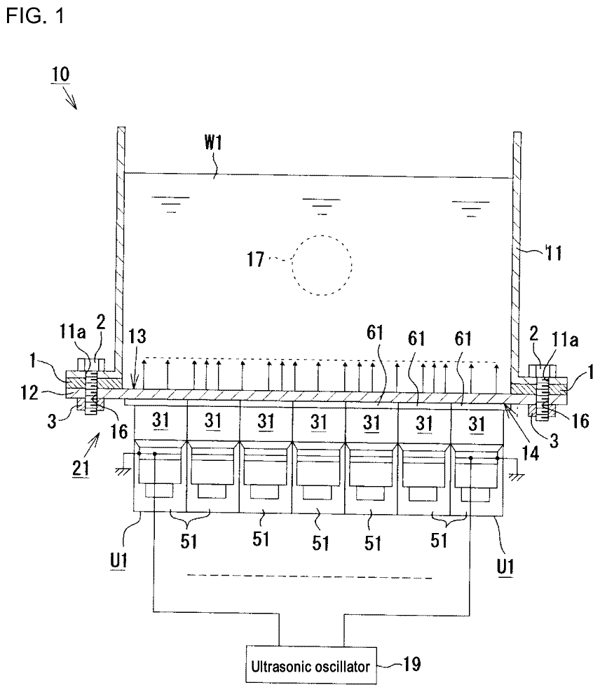

The first embodiment of the present invention, which is embodied in an ultrasonic cleaning device, will be described in detail below with reference to FIGS. 1 to 9.

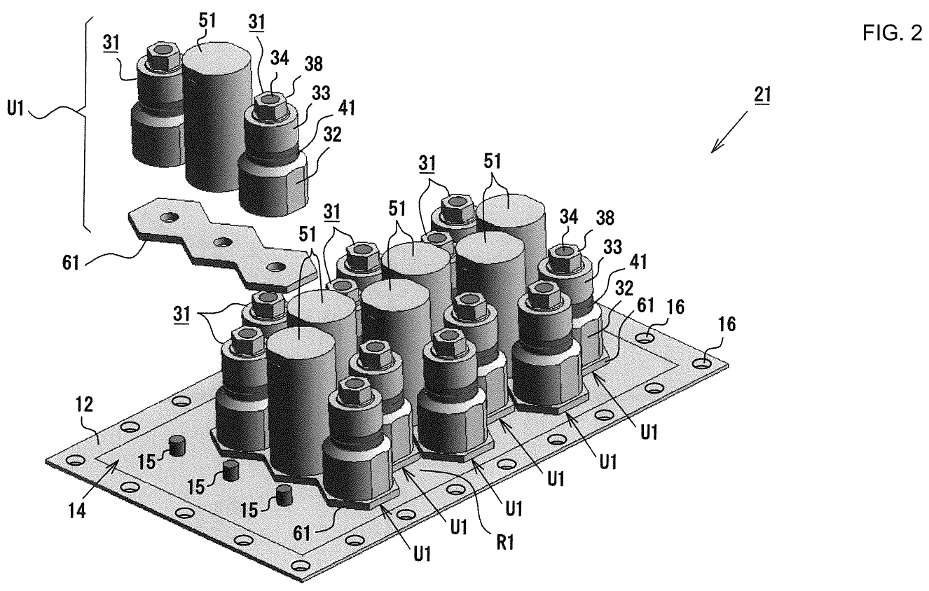

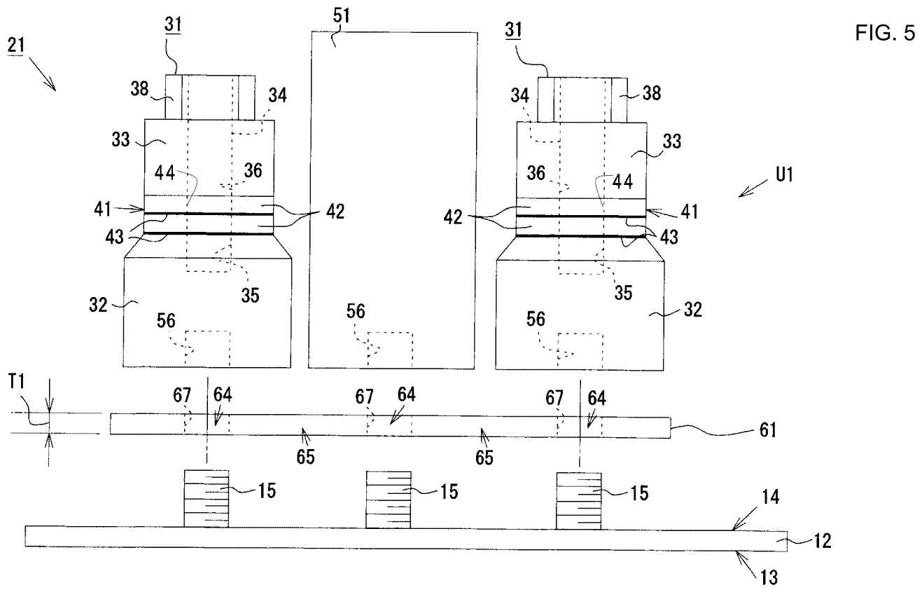

As shown in FIGS. 1 to 3, the ultrasonic cleaning device 10 includes a metal cleaning tank 11 that stores the cleaning liquid W1 and an ultrasonic-wave irradiation unit 21. A plurality of bolt holes 11a are provided at the lower end of the cleaning tank 11. The diaphragm 12 in the ultrasonic-wave irradiation unit 21 forms the bottom of the cleaning tank 11 and is a substantially rectangular metal plate (stainless steel plate in this embodiment) with dimensions of 390 mm in length, 240 mm in width, and 2.5 mm in thickness. That is, the ultrasonic-wave irradiation unit 21 of the present embodiment is a diaphragm-type ultrasonic-wave irradiation unit in which the diaphragm 12 is placed at the lower end of the cleaning tank 11 via a gasket 1 and the diaphragm 12 is fastened by bolts 2 and nuts 3. The diaphragm 12 has an irradiation surface 13 that irradiates ultrasonic waves and a non-irradiation surface 14 located on the opposite side of the irradiation surface 13. A plurality of stud bolts 15 (see FIGS. 2 and 5) are protrusively provided at multiple locations on the non-irradiation surface 14 of the diaphragm 12. A plurality of fixing holes 16 are provided at equal intervals along the entire circumference of the outer peripheral portion of the diaphragm 12.

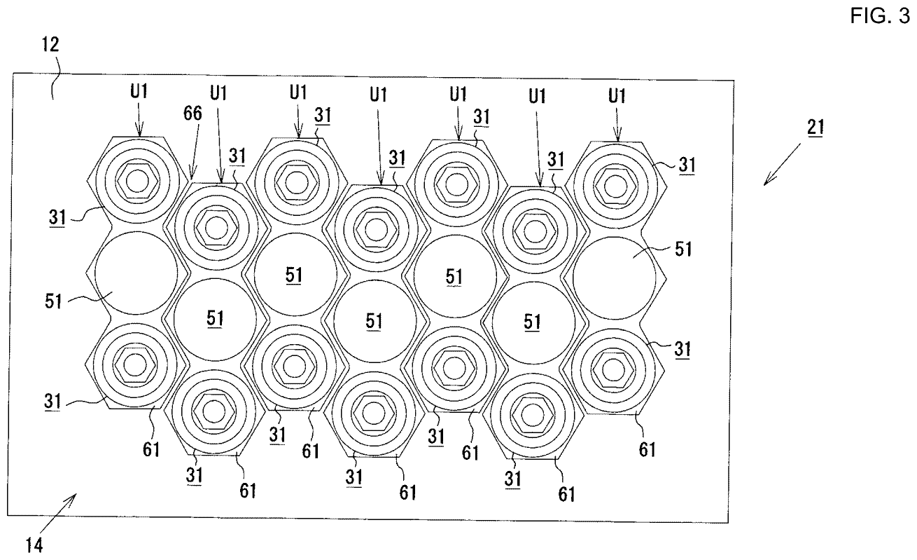

As shown in FIGS. 2 and 3, the ultrasonic-wave irradiation unit 21 includes the aforementioned diaphragm 12 and a plurality of transducer units U1. Although the number of transducer units U1 is not particularly limited, there are seven units in this embodiment. Each transducer unit U1 comprises a plurality of ultrasonic transducers 31, resonant rods 51 (resonators) arranged between the plurality of ultrasonic transducers 31, and a connecting plate 61 serving as a vibration transmission member. Specifically, in this embodiment, each transducer unit U1 has a structure in which one resonant rod 51 is arranged between two ultrasonic transducers 31. The connecting plate 61 mechanically couples the two ultrasonic transducers 31 and the one resonant rod 51, and transmits the ultrasonic oscillations generated by the two ultrasonic transducers 31 to the resonant rod 51. The ultrasonic cleaning device 10 of the present embodiment, which uses the above-mentioned transducer units U1, is configured as a device that irradiates ultrasonic waves from each ultrasonic transducer 31 into the cleaning liquid W1 in the cleaning tank 11, thereby cleaning the surface of an object 17 (see FIG. 1) placed in the cleaning tank 11.

As shown in FIGS. 2, 5, and 6, each ultrasonic transducer 31 is a device for irradiating ultrasonic waves, and is composed of a front transducer plate 32, a back transducer plate 33, a driving unit 41, and a transducer assembly bolt 34. That is, each ultrasonic transducer 31 of the present embodiment is a bolt-clamped Langevin-type transducer (BLT). The front transducer plate 32 is arranged on the front end side of each ultrasonic transducer 31. The front transducer plate 32 has a circular shape when viewed in plan and has a substantially cylindrical shape. The circular irradiation surface of the front transducer plate 32 is bonded to the upper surface of the connecting plate 61 via an adhesive such as an epoxy resin. The lower surface of the connecting plate 61 is bonded to the non-irradiation surface 14 of the diaphragm 12 via an adhesive such as an epoxy resin. The front transducer plate 32 is formed using metallic materials such as aluminum, aluminum alloys, stainless steel, or titanium alloys.

The back transducer plate 33 is arranged on the rear end side of each ultrasonic transducer 31. The back transducer plate 33 has a circular shape when viewed in plan and a substantially cylindrical shape. In this embodiment, the back transducer plate 33 is set to have a slightly smaller diameter than the front transducer plate 32. The driving unit 41 is composed of two piezoelectric elements 42 and two electrode plates 43 alternately laminated together, and is sandwiched between the front transducer plate 32 and the back transducer plate 33. The back transducer plate 33 is formed using metallic materials such as aluminum, aluminum alloys, stainless steel, or titanium alloys.

Each piezoelectric element 42 has an annular shape, and each electrode plate 43 has a substantially annular shape with a tab portion. Accordingly, the driving unit 41 has a bolt insertion hole 44 passing through its center. Each piezoelectric element 42 is polarized in the thickness direction.

The piezoelectric element 42 of the present embodiment is not particularly limited, but is formed using a ceramic piezoelectric material containing Pb (lead), such as lead zirconate titanate (PZT). Alternatively, the piezoelectric element 42 may be formed using a lead-free ceramic piezoelectric material, specifically, an alkali niobate-based ceramic piezoelectric material.

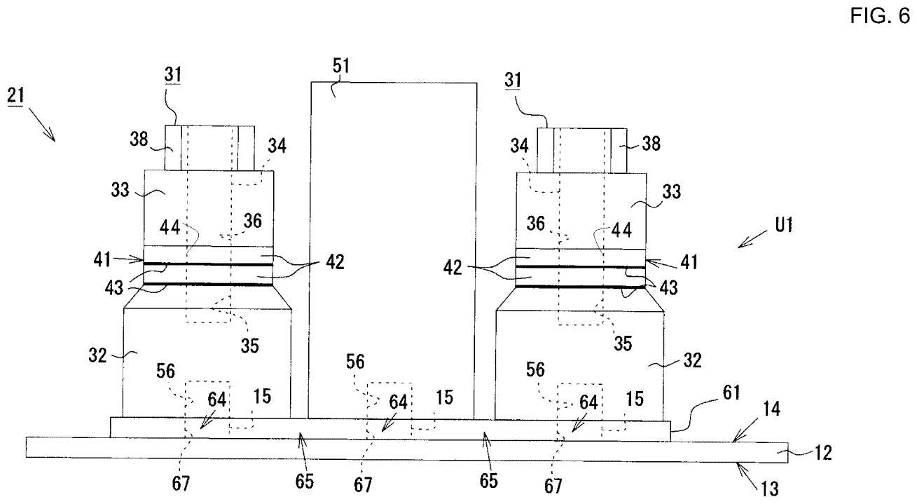

As shown in FIGS. 5 and 6, a female screw hole 35 extending in the height direction of the front transducer plate 32 (the vertical direction in FIGS. 5 and 6) is formed at the center of the rear end side of the front transducer plate 32. This female screw hole 35 does not penetrate through the front transducer plate 32. In other words, this female screw hole 35 is open only at the rear surface of the front transducer plate 32. On the other hand, a bolt insertion hole 56, through which the stud bolt 15 is inserted, is provided at the center of the front-end side of the front transducer plate 32, extending along the height direction.

The female screw hole 35 of the front transducer plate 32 is connected to the bolt insertion hole 44 of the driving unit 41. On the other hand, a through-hole 36 extending in the height direction of the back transducer plate 33 (the vertical direction in FIG. 3) is formed at the center of the back transducer plate 33. The through-hole 36 opens at the front end and is connected to the bolt insertion hole 44, and it also opens at the rear end. A transducer assembly bolt 34, which has a male screw formed on its outer peripheral surface, is inserted from the side of the back transducer plate 33, and its tip reaches the female screw hole 35 on the side of the front transducer plate 32 through the through-hole 36 and the bolt insertion hole 44. In other words, the tip of the transducer assembly bolt 34 stops halfway inside the front transducer plate 32 and does not reach the diaphragm 12. This transducer assembly bolt 34 is screwed into the female screw hole 35. The front transducer plate 32, the driving unit 41, and the back transducer plate 33 are tightened and fixed together as an integrated unit by screwing a nut 38 onto the protruding portion of the transducer assembly bolt 34 that passes through the back transducer plate 33. The metal material used to form the transducer assembly bolt 34 and the nut 38 is arbitrary; however, stainless steel is used in this embodiment.

A plurality of bolt insertion holes 67 are formed through the connecting plate 61, and a plurality of stud bolts 15 protruding through these bolt insertion holes 67 are screwed into the bolt insertion holes 56 of the front transducer plate 32. By this screwing, two ultrasonic transducers 31 are fastened and fixed to a single connecting plate 61. It can be understood that the connecting plate 61 is fastened and fixed in a state where it is held between the ultrasonic transducers 31 and the diaphragm 12 by the screwing of the stud bolts 15 into the bolt insertion holes 56 of the front transducer plate 32.

Each ultrasonic transducer 31 of the present embodiment, as shown in FIG. 1 and other figures, is a bolt-clamped Langevin-type transducer that resonates at a longitudinal primary oscillation mode (with a resonance frequency of 25 kHz when considered individually) having a longitudinal oscillation component in the axial direction of λ/2 (λ: wavelength of longitudinal oscillation). Each ultrasonic transducer 31 is configured to oscillate at the same frequency.

As shown in FIG. 1, each ultrasonic transducer 31 is electrically connected to an ultrasonic oscillator 19. The ultrasonic oscillator 19 supplies high-frequency power to continuously vibrate each ultrasonic transducer 31. Each ultrasonic transducer 31 is driven by this high-frequency power, and ultrasonic waves at 25 kHz (resonance frequency when each ultrasonic transducer 31 is joined to the diaphragm 12) are irradiated into the cleaning liquid W1 in the cleaning tank 11 by each ultrasonic transducer 31. In this embodiment, the ultrasonic output is set to 250 W, but it is not particularly limited to this value and can be set arbitrarily.

As shown in FIGS. 1 to 3, 5, and 6, each resonant rod 51 in the present embodiment is a resonator that resonates at the same frequency (resonance frequency of 25 kHz when considered individually) and at the longitudinal oscillation mode as the ultrasonic transducer 31. The resonant rod 51 has a circular shape when viewed in plan and a substantially cylindrical shape. In the present embodiment, each resonant rod 51 has the same diameter as the maximum diameter of the front transducer plate 32 and is formed to be slightly longer than the ultrasonic transducer 31. A bolt insertion hole 56, through which the stud bolt 15 is inserted, is formed at the center of the front-end side of the resonant rod 51, extending along the height direction. The plurality of stud bolts 15 protruding through the insertion holes 67 are screwed into the bolt insertion holes 56 of the resonant rod 51. By this screwing, a single resonant rod 51 is fastened and fixed to a single connecting plate 61. The resonant rod 51 is formed using metallic materials such as aluminum, aluminum alloys, stainless steel, or titanium alloys.

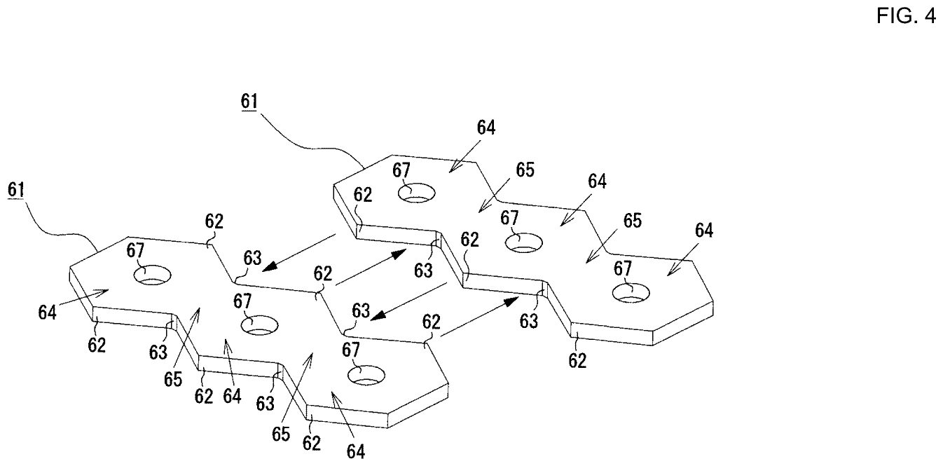

As shown in FIGS. 3 and 4, the connecting plate 61 is a member made of a metal flat plate, and the connecting plate 61 in the present embodiment has a structure in which three regular hexagonal plates made of aluminum are arranged in the planar direction and integrally connected. The connecting plate 61 has a plurality of peaks 62 and a plurality of valleys 63 along both side edges. The peaks 62 and valleys 63 are portions formed in a substantially bent shape and are regularly formed at equal pitches. As a result, the connecting plate 61 has three wide portions 64 and two narrow portions 65, with these wide portions 64 and narrow portions 65 being alternately formed. It can also be understood that the connecting plate 61 is provided with zigzag-shaped side edges (i.e., linear edges that bend back at angles and reverse direction at regular intervals) on both sides. In this connecting plate 61, the dimension of the wide portion 64 is approximately twice the dimension of the narrow portion 65. In the connecting plate 61 of the present embodiment, bolt insertion holes 67, through which the stud bolts 15 can be inserted, are respectively formed through the center of each of the three wide portions 64 (i.e., the center of each regular hexagonal plate).

The thickness of the connecting plate 61 is not particularly limited and can be set arbitrarily; however, it is preferable that the thickness is between 1/200 and 1/10 of the wavelength of the longitudinal oscillation at the driving frequency of the ultrasonic waves. This is because if the connecting plate 61 is too thick, it may become difficult to connect the ultrasonic transducers 31 and the resonant rods 51, and if it is too thin, bending vibrations are more likely to occur. In the present embodiment, considering the above factors, the thickness of the connecting plate 61 is set to approximately 5 mm to 10 mm (i.e., approximately 1/20 to 1/10 of the wavelength of the longitudinal oscillation).

As shown in FIGS. 3 and 4, adjacent connecting plates 61 are arranged in close proximity in an alternating manner, such that the peaks 62 fit into the valleys 63. A certain gap 66 is maintained between adjacent connecting plates 61. The size of the gap 66 is not limited, but it is set, for example, to 0.1 mm or more, preferably 0.3 mm or more. If the gap 66 is too narrow, the adjacent connecting plates 61 may come into contact when installed, which may result in interference between adjacent transducer units U1 and cause significant loss of vibration energy. Furthermore, the size of the gap 66 is set to, for example, ⅛ or less of the wavelength of the longitudinal vibration at the driving frequency of the ultrasonic waves, preferably 1/15 or less, and more preferably 1/30 or less. If the gap 66 is too wide, bending vibration is likely to occur, making it difficult to achieve uniform longitudinal vibration. In this embodiment, considering the above factors, the gap 66 between the connecting plates 61 is set to approximately 1 mm to 2 mm (i.e., approximately 1/100 to 1/50 of the wavelength of the longitudinal vibration).

The seven transducer units U1 in the present embodiment are installed on the non-irradiation surface 14 side of the diaphragm 12 by fastening and securing the ultrasonic transducers 31 and the resonant rods 51 to the plurality of stud bolts 15 protruding through the bolt insertion holes 67 of the connecting plates 61. At this time, the adjacent transducer units U1 are installed with an offset equal to half the pitch between the peaks 62 or between the valleys 63. As a result, the plurality of ultrasonic transducers 31 belonging to different transducer units U1 are arranged in a staggered pattern along the width direction of the transducer units U1 (the direction in which the transducer units U1 are arranged). Similarly, the plurality of resonant rods 51 belonging to different transducer units U1 are also arranged in a staggered pattern along the width direction of the transducer units U1.

The ultrasonic transducers 31 and the resonant rods 51 that make up the transducer units U1 are formed to be smaller than the diameter of the inscribed circle of the regular hexagonal plates that constitute the connecting plate 61. Preferably, they are formed to be 80% or more, but less than 100%, of the diameter of the inscribed circle of the regular hexagonal plates. If the dimensions of the ultrasonic transducers 31 and the resonant rods 51 are equal to or larger than the diameter of the inscribed circle, the ultrasonic transducers 31 and the resonant rods 51 may project beyond the sides of the connecting plate 61, potentially coming into contact with adjacent connecting plates 61. Conversely, if the dimensions of the ultrasonic transducers 31 and the resonant rods 51 are too small, sufficient ultrasonic oscillation may not be achieved. In light of these considerations, in the present embodiment, the dimensions of both the ultrasonic transducers 31 and the resonant rods 51 are set to approximately 95% of the diameter of the inscribed circle.

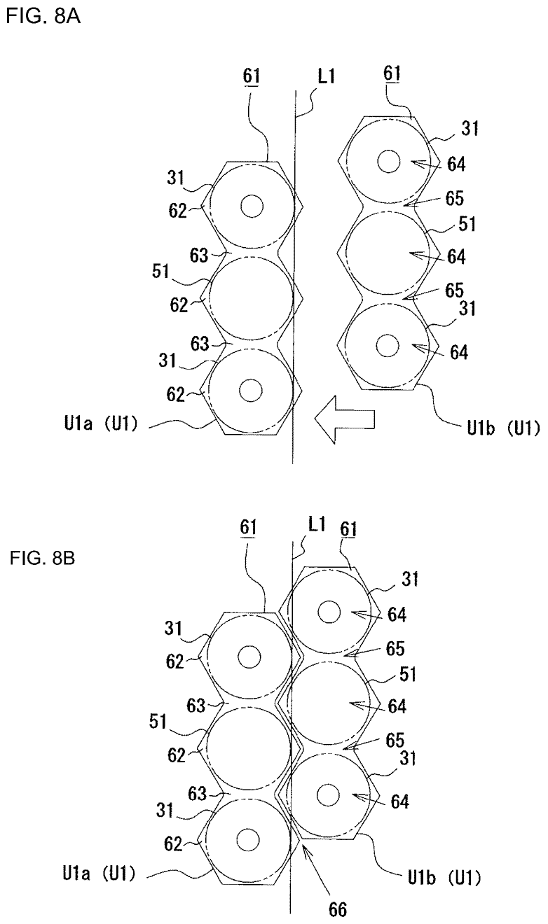

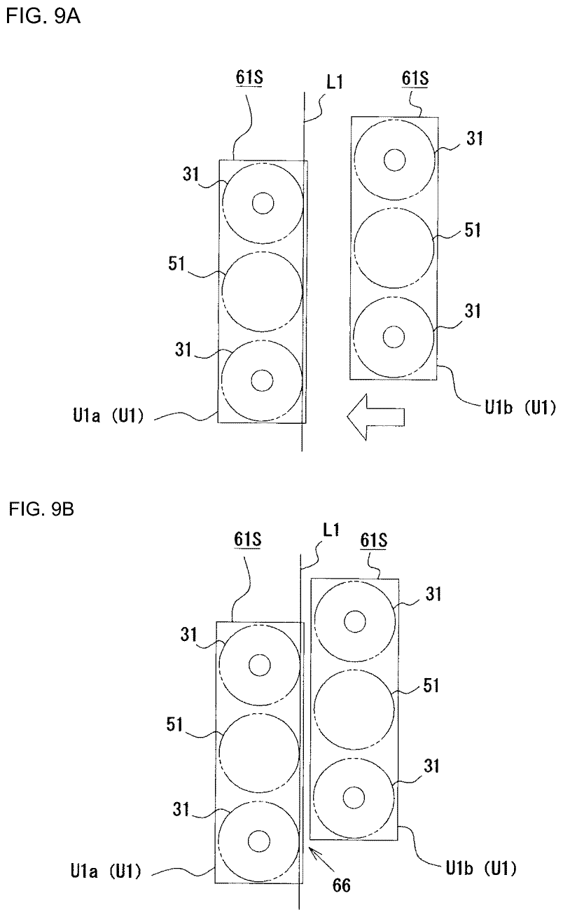

FIGS. 8A and 8B are plan views illustrating the state in which adjacent connecting plates 61 are arranged in close proximity in the transducer unit U1 of the embodiment. FIGS. 9A and 9B are plan views illustrating the state in which adjacent connecting plates 61S are arranged in close proximity in the transducer unit U1 of Comparative Example 1.

Here, a specific transducer unit U1 chosen arbitrarily is defined as the “reference unit U1a,” and a transducer unit U1 adjacent to the specific transducer unit U1 is defined as the “adjacent unit U1b.” In this case, a linear segment L1 circumscribing the two ultrasonic transducers 31 belonging to the reference unit U1a is assumed.

In the embodiment, as described above, the connecting plates 61 have a zigzag shape with multiple peaks 62 and valleys 63 formed along their side edges. The adjacent connecting plates 61 are arranged such that the peaks 62 of one plate fit into the valleys 63 of the adjacent plate. Therefore, in this embodiment, when the reference unit U1a and the adjacent unit U1b are arranged in close proximity with a gap 66 between them, the outer periphery of the two ultrasonic transducers 31 and one resonant rod 51 belonging to the adjacent unit U1b intersects the line segment L1 (see FIG. 8B. This indicates that, in this embodiment, the ultrasonic transducers 31 and resonant rods 51 belonging to adjacent transducer units U1 can be positioned very closely to each other.

In contrast, in Comparative Example 1, the connecting plate 61S is rectangular, and its side edges are linear, with neither peaks 62 nor valleys 63 present. Therefore, even when the reference unit U1a and the adjacent unit U1b are arranged in close proximity with a gap 66 between them, the outer peripheries of the two ultrasonic transducers 31 and one resonant rod 51 belonging to the adjacent unit U1b do not intersect with the linear segment L1 (see FIG. 9B. This indicates that in Comparative Example 1, the ultrasonic transducers 31 and resonant rods 51 belonging to adjacent transducer units U1 cannot be arranged as closely as in the embodiment.

Next, the operation of the ultrasonic cleaning device 10 in this embodiment will be explained.

First, the ultrasonic cleaning device 10 is activated, and high-frequency power is supplied from the ultrasonic oscillator 19 to the multiple ultrasonic transducers 31, causing each ultrasonic transducer 31 to vibrate continuously. As a result, ultrasonic waves are irradiated into the cleaning liquid W1 from the ultrasonic transducers 31. At this time, cavitation occurs in the cleaning liquid W1 due to the irradiation of ultrasonic waves, and the impact generated by the collapse of the cavitation bubbles cleans the object 17 to be cleaned.

Next, the evaluation test of the ultrasonic-wave irradiation unit 21 and its results will be explained.

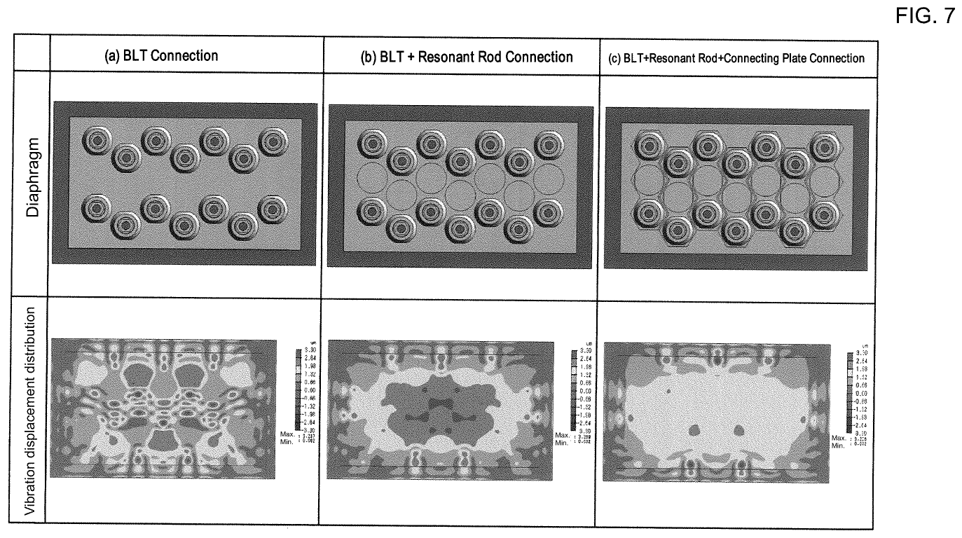

In this evaluation test, the measurement samples were prepared as follows. An ultrasonic-wave irradiation unit 21, identical to that in the present embodiment, was prepared as the embodiment. The ultrasonic-wave irradiation unit 21 of the embodiment is listed in the right column of the table in FIG. 7 as “(c) BLT+Resonant Rod+Connecting Plate Connection.” Additionally, an ultrasonic-wave irradiation unit without the connecting plate 61 from the present embodiment was prepared as Comparative Example 2. The ultrasonic-wave irradiation unit for Comparative Example 2 is listed in the middle column of the table in FIG. 7 as “(b) BLT+Resonant Rod Connection.” Furthermore, an ultrasonic-wave irradiation unit without both the connecting plate 61 and the resonant rod 51 from the present embodiment was prepared as Comparative Example 3. The ultrasonic-wave irradiation unit for Comparative Example 3 is listed in the left column of the table in FIG. 7 as “(a) BLT Connection.”

Next, using the well-known finite element method (FEM) analysis, the oscillation displacement distribution of the diaphragm 12 under water-loaded conditions was analyzed for each measurement sample (the embodiment, Comparative Example 2, and Comparative Example 3). In this analysis, a diaphragm 12 with dimensions of 390 mm in length, 240 mm in width, and 2.5 mm in thickness was used. The ultrasonic-wave irradiation unit was constructed by mounting 14 ultrasonic transducers 13 (HEC-45282, manufactured by Honda Electronics Co., Ltd.) on the non-irradiation surface 14 of the diaphragm 12 and driving them at a nominal frequency of 28 kHz. The driving power for each ultrasonic transducer 13 was set to 600 W.

As a result, it was confirmed that the oscillation displacement distribution was more uniform in Comparative Example 2 than in Comparative Example 3, and even more uniform in the embodiment than in Comparative Example 2. Therefore, it was concluded that the uniformity of the oscillation displacement distribution was highest in “(c) BLT+Resonant Rod+Connecting Plate Connection,” followed by “(b) BLT+Resonant Rod Connection,” and lowest in “(a) BLT Connection.”

Therefore, according to the present embodiment, the following effects can be achieved.
(1) The ultrasonic-wave irradiation unit 21 in the present embodiment is constructed using multiple transducer units U1, each of which mechanically connects two ultrasonic transducers 31 and one resonant rod 51 via a connecting plate 61. As a result, the resonant rod 51 is excited by the resonance phenomenon that occurs with the vibration of the ultrasonic transducers 31. At this time, the connecting plate 61 functions as an irradiation plate for the vibrating body consisting of two ultrasonic transducers 31 and one resonant rod 51, enabling uniform longitudinal vibration over a relatively wide radiation surface. Furthermore, the adjacent connecting plates 61 are closely arranged in a staggered pattern, with the peaks 62 fitting into the valleys 63, allowing the ultrasonic transducers 31 and resonant rods 51 to be positioned densely. Consequently, the bending vibration that occurs in the gaps 66 between the transducer units U1 is suppressed, reducing erosion on the diaphragm 12 and making it more resistant to wear, thereby extending the service life of the device. Additionally, the uniformity of the oscillation displacement distribution is improved, reducing the occurrence of uneven cleaning. As a result, a superior ultrasonic cleaning device 10 that enables uniform cleaning can be provided.

In addition, the cylindrical resonator 51 in this embodiment, which consists of a single material, has a simpler structure than the ultrasonic transducers 31, which are composed of multiple components, and can therefore be manufactured at a relatively low cost. The connecting plate 61 in this embodiment also has a relatively simple structure, allowing it to be produced at a relatively low cost through sheet metal processing methods such as stamping or laser cutting. Therefore, even in an ultrasonic-wave irradiation unit 21 equipped with a diaphragm 12 that requires a large cleaning area, the use of low-cost resonant rods 51 and connecting plates 61, instead of deploying a large number of ultrasonic transducers 31, makes it possible to achieve a device that offers excellent erosion resistance and uniformity in the oscillation displacement distribution at a reduced cost.
(2) In the ultrasonic-wave irradiation unit 21 of this embodiment, the multiple ultrasonic transducers 31 and resonant rods 51 are both arranged in a staggered pattern along the width direction of the transducer unit U1. Furthermore, the outer peripheries of the ultrasonic transducers 31 and resonant rods 51 belonging to the adjacent unit U1b intersect with the linear segment L1, which circumscribes the two ultrasonic transducers 31 of the reference unit U1a. This configuration makes it relatively easy to position the ultrasonic transducers 31 and resonant rods 51 densely with respect to one another.
(3) In this embodiment, the peaks 62 and valleys 63 are formed at regular intervals with an equal pitch. Therefore, when the adjacent connecting plates 61 are arranged in a staggered pattern, with the peaks 62 fitting into the valleys 63, a substantially uniform and narrow gap 66 can be provided between them. In Comparative Example 1, by contrast, the gap 66 between the adjacent transducer units U1 is linear, making it easier for bending vibration to be excited along the linear gap 66. As a result, depending on the vibration level, there is a risk of heat generation and stress fractures. Therefore, suppressing bending vibration is considered necessary for practical applications. In this embodiment, however, since the gap 66 between the adjacent transducer units U1 is non-linear (zigzag-shaped) and narrow, bending vibration is less likely to be excited compared to Comparative Example 1. Consequently, this embodiment has the advantage of reducing concerns about heat generation or stress fractures.
(4) For example, Japanese Patent No. 7171117 discloses an ultrasonic-wave irradiation unit constructed using a block-shaped base member in which the front portion of the resonant rod and the front portion of the ultrasonic transducer are integrated. This ultrasonic-wave irradiation unit has the advantage of providing both excellent vibration distribution uniformity and erosion resistance. On the other hand, the cost of machining narrow grooves in the base member is relatively high, which results in increased manufacturing costs for the device. In contrast, the connecting plate 61 used in this embodiment can be manufactured at a relatively low cost, as described above, and thus does not lead to higher manufacturing costs for the device.

### Second Embodiment

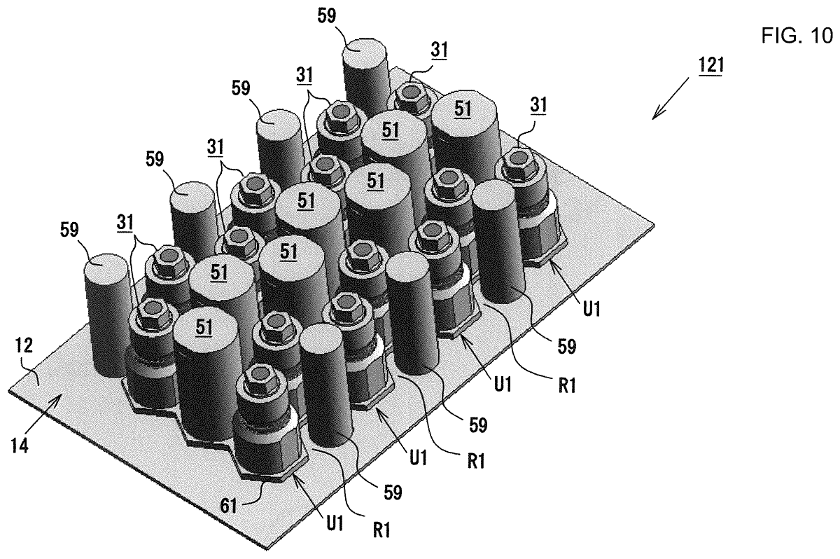

Next, the ultrasonic-wave irradiation unit 121 of the second embodiment of the present invention will be described in detail with reference to FIG. 10. In this section, we will focus on the structural differences from the ultrasonic-wave irradiation unit 21 of the first embodiment. For components that are identical to those in the first embodiment, the same reference numerals are used, and detailed descriptions are omitted.

In the first embodiment, a substantially trapezoidal region R1 (see FIG. 2, etc.) exists on the non-irradiation surface 14 of the diaphragm 12, along the extended line in the longitudinal direction of the transducer unit U1, where no connecting plate 61 is present. However, no specific structures were provided in that region. In contrast, in the ultrasonic-wave irradiation unit 121 of this embodiment, stud bolts 15 are also protruding in the region R1. Resonant rods 59, which serve as second resonators, are fastened and fixed to these stud bolts 15. Additionally, the substantially trapezoidal region R1 occupies approximately half the area of the hexagonal plate that forms the connecting plate 61. To install the resonant rods 59 in this region R1, their diameter is made slightly smaller than that of the resonant rods 51 (first resonators) belonging to the transducer unit U1.

According to the configuration of the ultrasonic-wave irradiation unit 121 described above, similar to the first embodiment, erosion on the diaphragm 12 and uneven cleaning can be reduced, while manufacturing costs remain relatively low. In addition, compared to the first embodiment, this configuration further minimizes variations in the oscillation displacement distribution within specific regions, achieving even greater uniformity in the distribution. It is also conceivable to extend the connecting plate 61 to the substantially trapezoidal region R1 and install the resonant rods 59 through the extended portion. However, this configuration would not sufficiently reduce variations in the oscillation displacement distribution in specific regions. Therefore, in this embodiment, the resonant rods 59 are intentionally installed directly in the region R1.

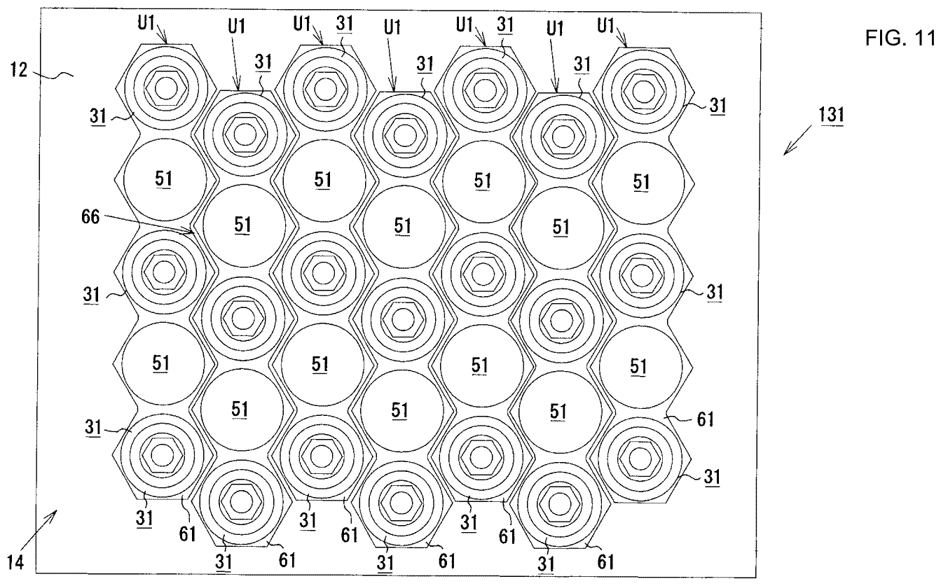

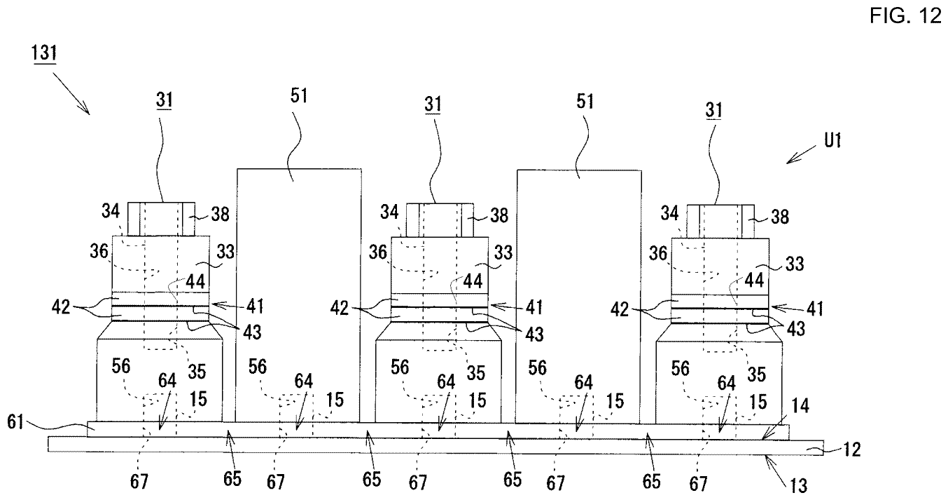

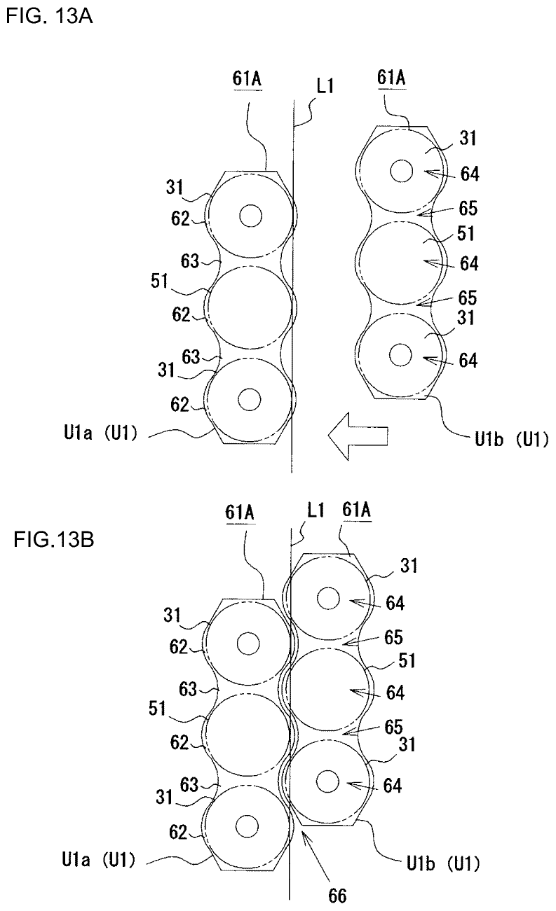

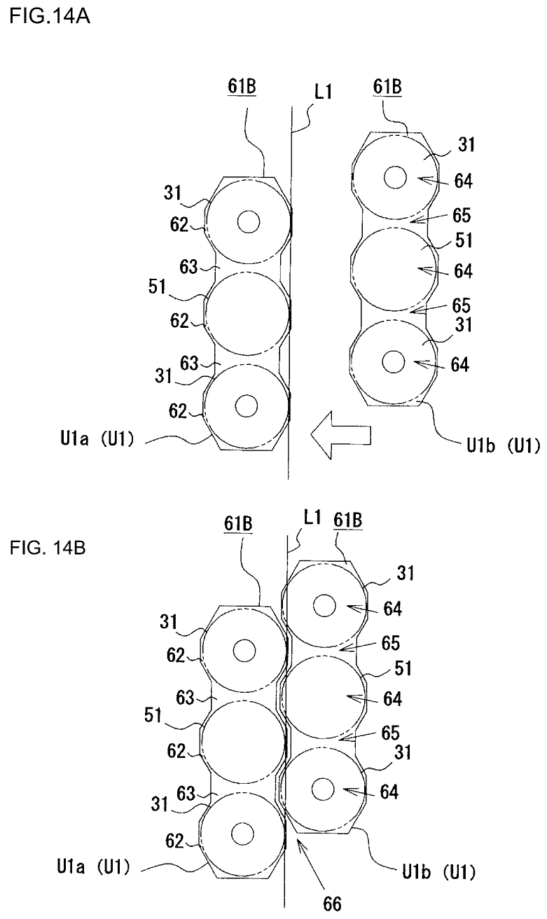

The above embodiment may be modified as follows.
In the above embodiment, each individual transducer unit U1 is composed of two ultrasonic transducers 31 and one resonator 51, with one resonator 51 arranged between the two ultrasonic transducers 31. However, this configuration is not limited to that arrangement. For example, as shown in FIGS. 11 and 12, another embodiment of the transducer unit 131 may include three ultrasonic transducers 31 and two resonators 51, with one resonator 51 positioned between each pair of ultrasonic transducers 31.
In the above embodiment, the transducer unit U1 is configured using resonant rods 51 that are circular in plan view and have a substantially cylindrical shape. However, this configuration is not limited to that. For example, the transducer unit U1 may also be constructed using resonant rods that are rectangular in plan view and have a substantially prismatic shape.
In the above embodiment, the transducer unit U1 is configured using connecting plates 61 with zigzag-shaped side edges, formed by multiple substantially V-shaped peaks 62 and multiple substantially V-shaped valleys 63. However, this configuration is not limited to that. For example, as shown in FIGS. 13A and 13B, the transducer unit U1 may be constructed using connecting plates 61A with wavy side edges, where multiple peaks 62 and multiple valleys 63 are arranged in an arc shape. Even in this case, the adjacent connecting plates 61A can be arranged in close proximity, with the peaks 62 fitting into the valleys 63. Alternatively, the transducer unit U1 may also be constructed using connecting plates 61B, as shown in FIGS. 14A and 14B. Similarly, even in this case, the adjacent connecting plates 61B can be arranged in close proximity, with the peaks 62 fitting into the valleys 63.
In the above embodiment, stud bolts 15, which are bolts without heads, were used as the bolts protruding from the non-irradiation surface 14 of the diaphragm 12. However, bolts with heads, such as hex bolts, hex socket bolts, wing bolts, or the like, may also be used as the bolts protruding from the non-irradiation surface 14.
In the above embodiment, the ultrasonic-wave irradiation units 21, 121, and 131 of the diaphragm type were installed on the bottom of the cleaning tank 11 of the ultrasonic cleaning apparatus 10 via a gasket 1. However, this configuration is not limited to that. For example, the ultrasonic-wave irradiation units 21, 121, and 131 may also be of the tank type, attached to stud bolts protruding from the non-irradiation surface of the bottom plate of the cleaning tank 11. Alternatively, the ultrasonic-wave irradiation units 21, 121, and 131 may be of the submersible type, used by being immersed directly into the cleaning liquid W1 inside the cleaning tank 11.
In the above embodiments, the ultrasonic-wave irradiation units 21, 121, and 131 were applied to the ultrasonic cleaning apparatus 10, which performs cleaning using ultrasonic waves. However, these units are not limited to cleaning applications and may also be applied to devices for processes such as extraction, emulsification, dispersion, mixing, stirring, crushing, atomization, and the like. Specifically, for example, when the ultrasonic-wave irradiation unit is applied to an ultrasonic emulsification device, it can efficiently refine emulsions to the nanoparticle level, achieving long-term stabilization and reducing the amount of surfactants required, among other benefits.

Moreover, when the ultrasonic-wave irradiation unit is applied to an ultrasonic dispersion device, it can efficiently disperse various types of nanoparticles, such as metal nanoparticles, carbon nanotubes, ceramic nanoparticles, magnetic nanoparticles, and the like. Furthermore, the ultrasonic-wave irradiation unit may also be embodied as an ultrasonic treatment device that utilizes chemical actions. In this case, cavitation can be efficiently generated uniformly and over a wide area, increasing the generation of radicals, such as OH radicals, that are produced under the high-temperature and high-pressure conditions created during bubble collapse. As a result, the reaction efficiency of sonochemical processes caused by radicals can be enhanced, enabling efficient processing for applications such as decomposing and detoxifying harmful substances, sterilization, polymerization, and the like.

Next, in addition to the technical concepts described in the claims, the following technical concepts can be understood from the embodiments described above.
(1) In the first aspect of the present invention and the like, the diaphragm and the connecting plate are joined in surface contact via an adhesive, and the ultrasonic transducer and the resonator are also joined in surface contact with the connecting plate via the adhesive.
(2) In the first aspect of the present invention and the like, the ultrasonic transducer is a longitudinal vibration transducer that oscillates in a longitudinal vibration mode, and the resonator resonates at the same frequency and in the same longitudinal vibration mode as the ultrasonic transducer.
(3) In the first aspect of the present invention and the like, the ultrasonic transducer and the resonator are smaller in size than the diameter of the inscribed circle of the hexagonal plate that forms the connecting plate.
(4) In the first aspect of the present invention and the like, the ultrasonic transducer and the resonator are at least 80% and less than 100% of the diameter of the inscribed circle of the hexagonal plate that forms the connecting plate.
(5) In the first aspect of the present invention and the like, one transducer unit is configured by placing one resonator between two ultrasonic transducers.
(6) In the first aspect of the present invention and the like, the resonator is a resonant rod longer than the ultrasonic transducer.
(7) In the first aspect of the present invention and the like, bolts are protrudingly provided in the region along the longitudinal extension of the transducer unit where the connecting plate is absent, and resonators with a smaller diameter are fastened to these bolts.

### DESCRIPTION OF REFERENCE NUMERALS

12: Diaphragm
13: Irradiation surface
14: Non-irradiation surface
15: Stud bolt (as a bolt)
21, 121, 131: Ultrasonic-wave irradiation units
31: Ultrasonic transducer
51: Resonant rod (first resonator)
59: Resonant rod (second resonator)
54: Bolt insertion hole
61, 61A, 61B: Connecting plate
62: Peak
63: Valley
64: Wide portion
65: Narrow portion
66: Gap
67: Bolt insertion hole
L1: Linear segment
t1: Thickness of the connecting plate
U1: Transducer unit
U1a: Reference unit
U1b: Adjacent unit

1. An ultrasonic-wave irradiation unit comprising:
a diaphragm having an irradiation surface that emits ultrasonic waves and a non-irradiation surface located on the opposite side of the irradiation surface, with a plurality of bolts protruding from the non-irradiation surface; and
a plurality of transducer units, each comprising a plurality of ultrasonic transducers, resonators, and a connecting plate;
wherein the resonators are arranged between the plurality of ultrasonic transducers;
wherein the connecting plate mechanically couples the plurality of ultrasonic transducers and the resonators and transmits the vibrations of the plurality of ultrasonic transducers to the resonators;
wherein the connecting plate has alternating wide portions and narrow portions formed by having peaks and valleys along both side edges, and a plurality of bolt insertion holes are formed through the center of each of the wide portions to allow the bolts to pass through;
wherein adjacent connecting plates are arranged in a staggered manner such that the peaks of one plate fit into the valleys of the other plate in close proximity;
wherein the plurality of ultrasonic transducers and resonators are fastened and secured to the bolts protruding through the bolt insertion holes of the connecting plates, and a plurality of transducer units are installed on the non-irradiation surface side.

2. The ultrasonic-wave irradiation unit according to claim 1, wherein the plurality of ultrasonic transducers and the resonators are both arranged in a staggered manner along the width direction of the transducer units.

3. The ultrasonic-wave irradiation unit according to claim 2, wherein, when a specific transducer unit is designated as the reference unit and a transducer unit adjacent to the specific transducer unit is designated as the adjacent unit, and a line segment circumscribing the plurality of ultrasonic transducers belonging to the reference unit is assumed, the outer periphery of the ultrasonic transducers and the resonators belonging to the adjacent unit intersects the line segment.

4. The ultrasonic-wave irradiation unit according to claim 3, wherein the peaks and valleys are formed regularly with an equal pitch.

5. The ultrasonic-wave irradiation unit according to claim 1, wherein the connecting plate has a structure in which a plurality of regular hexagonal plates are arranged and connected integrally in the planar direction.

6. The ultrasonic-wave irradiation unit according to claim 1, wherein adjacent connecting plates are arranged in close proximity with a gap of 0.1 mm or more and ⅛ or less of the longitudinal oscillation wavelength.

7. The ultrasonic-wave irradiation unit according to claim 1, wherein the thickness of the connecting plate is 1/200 or more and 1/10 or less of the longitudinal oscillation wavelength.
